(19) United States
(12) Patent Application Publication
(10) Pub. No.: US 2013/0291773 A1
(43) Pub. Date: Nov. 7, 2013

(54) SEED FIRMER LIFE EXTENDER

(71) Applicant: FLO-RITE, INC., Hicksville, OH (US)

(72) Inventor: Jeffrey J. Peter, Hicksville, OH (US)

(73) Assignee: Flo-Rite, Inc., Hicksville, OH (US)

(21) Appl. No.: 13/862,698

(22) Filed: Apr. 15, 2013

Related U.S. Application Data
(60) Provisional application No. 61/642,004, filed on May 3, 2012.

(51) Int. Cl. A01C 7/06

(52) U.S. Cl. CPC A01C 7/06
USPC 111/118; 111/189; 29/891

(57) ABSTRACT

The present invention involves a seed firmer with a pusher or embedding attachment that extends the life of the seed firmer. The seed firmer has a flexible portion adapted to be coupled to a seed chute of a planter. Also, a firming arm flexibly is connected to the flexible portion, with the firming arm having an engagement portion bounded at one end by a stop. Additionally, an extender attachment is mechanically coupled to the engagement portion and abuts the stop.

### CROSS REFERENCE TO RELATED APPLICATIONS

The present application claims priority under 35 U.S.C. §119(e) of U.S. Patent Provisional Application Ser. No. 61/642,004, filed May 3, 2012, the disclosures of which are incorporated by reference herein.

### BACKGROUND OF THE INVENTION

1. Field of the Invention

The invention relates to agricultural planting implements. More specifically, the field of the invention is that of seed firmers.

2. Description of the Related Art

Seed firmers are known and used extensively in agricultural planting systems. Such firmers add to the expense of a planting implement but are thought to more than pay for themselves in terms of increased yield. Improvements in the cost and performance of the firmer are always welcomed.

### SUMMARY OF THE INVENTION

The present invention is a seed firmer construction which provides a replaceable tip for extending the life of the firmer. The seed firmer generally has two components that wear, the flexible arm and the embedding pusher. The flexible arm generally lasts much longer than the embedding pusher portion because the pusher wears against the ground and eventually wears away. Embodiments of the invention include an embedding pusher portion that has a stop and a guide for accepting a replaceable extender. Thus, the portion of the firmer that wears down may be easily replaced which extends the life of the firmer.

The end of the firmer has a slot that is bounded by a stop portion. The embedding pusher attachment slides into the slot and abuts the stop portion. The bottom of the embedding pusher operates in a conventional manner pushing the seed downwardly into the ground to thus embed the seed in the soil. During the usable life of the firmer, the flexible portion may operate on several embedding pusher attachments.

The present invention, in one form, relates to a seed firmer having a flexible portion and an embedding pusher portion. The flexible portion biases the embedding pusher portion into the soil. The embedding pusher portion includes a slot for receiving an embedding pusher attachment, the stop bounded at the end by a stop portion which retains the embedding pusher attachment as it is drawn over the soil.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a side view of an embodiment of the firmer of the present invention shown in use.

FIG. 2 is a sectional view of FIG. 1 showing a through channel.

FIG. 3 is a perspective view of an embodiment of the extender of the present invention.

FIG. 4 is a side sectional view of the firmer of the present invention showing the interconnection of the extender and firmer body.

FIG. 5 is a perspective view of an end portion of an embodiment of the present invention.

Corresponding reference characters indicate corresponding parts throughout the several views. Although the drawings represent embodiments of the present invention, the drawings are not necessarily to scale and certain features may be exaggerated in order to better illustrate and explain the present invention. The flow charts and screen shots are also representative in nature, and actual embodiments of the invention may include further features or steps not shown in the drawings. The exemplification set out herein illustrates an embodiment of the invention, in one form, and such exemplifications are not to be construed as limiting the scope of the invention in any manner.

### DESCRIPTION OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings.

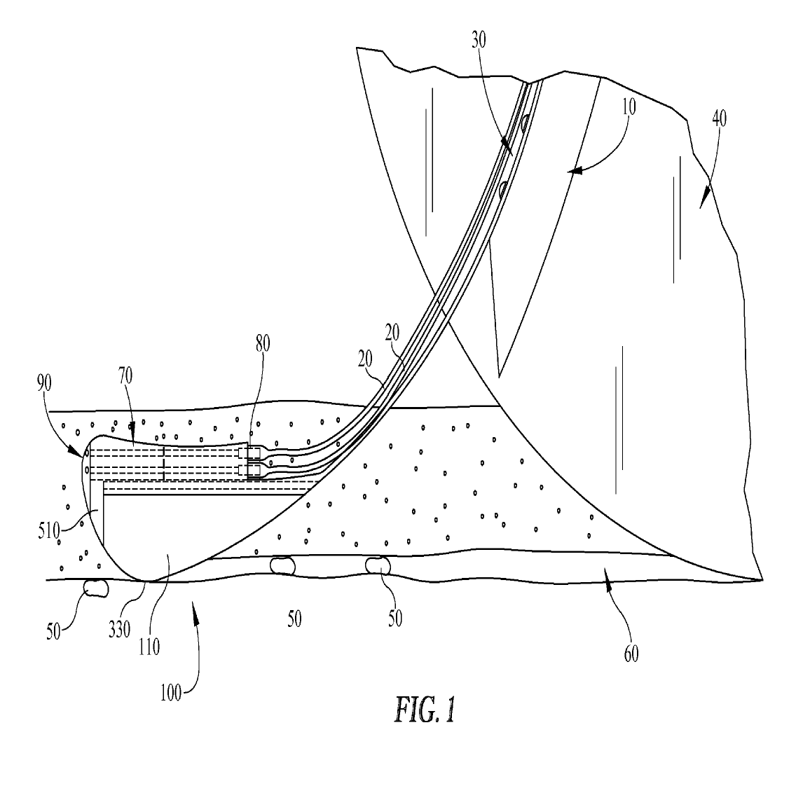

FIG. 1 shows seed firmer 100 disposed in operation, having embedding pusher portion, or extender, 110 positioned relative to seed chute 10 in a conventional manner. Seed chute 10 is positioned relative to disc 40 by mount 30 so that chute 10 delivers seeds 50 to trough 60, with extender portion 110 being so positioned to embed seeds 50 into the soil of trough 60. Firmer 100 includes interior channel 70 which extends from nipples 80 to end point 90, and is sized to receive tube 20, which in this exemplary embodiment involves conventional liquid tubes that deliver herbicides, fertilizers, pesticides, and/or mixtures of those chemicals to deposit on or near seed 50 once embedded.

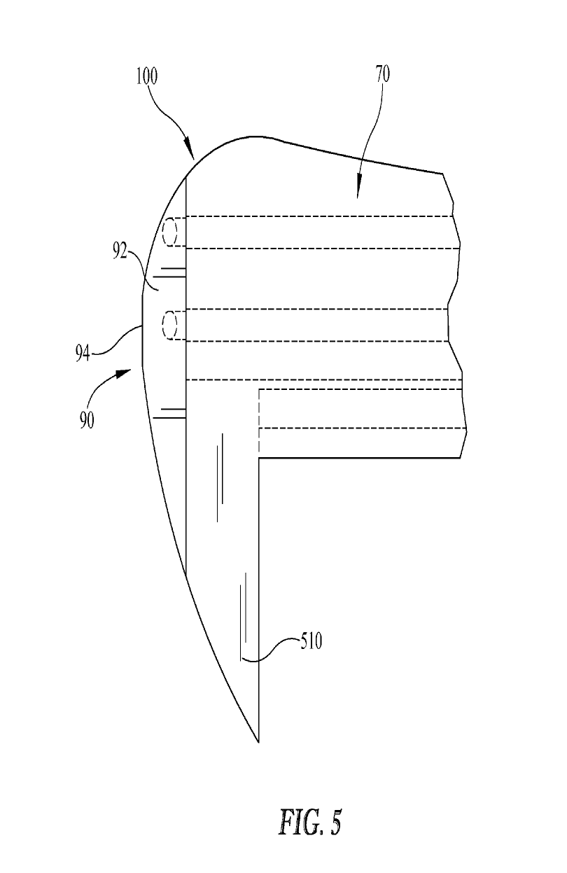

The firmer has an attachment portion, extender 110, that is located at the position on the firmer that contacts and embeds seeds 50 into the soil defining trough 60. In one embodiment, extender 110 fits into slot 410 in firmer 100 (see FIG. 4), with slot 410 bounded by hard stop portion 510 (see FIG. 5) that retains extender 110 against the direction of movement of firmer 100 over the soil. In this embodiment, extender 110 has tongue 420 having a “T” shape that slideably engages slot 410 so that when not in use, extender 110 may be easily replaced. When firmer 100 is in use, the force subjected to extender 110 urges it into hard stop 510. The exact shape and arrangement of the slideable engagement of slot 410 and tongue 420 may have several variations, for example a circular or arc shaped tongue and slot, or a tongue and slot with several angles.

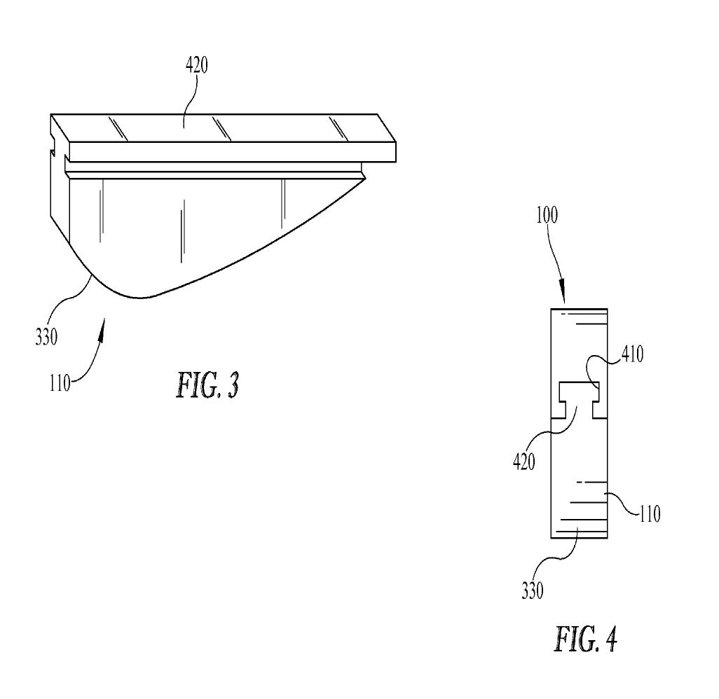

Extender 110 (see FIG. 3) may be made of conventional materials so that seeds 50 are pressed by the conventional surface and the material wears similarly to conventional firmers. However, once embedding surface 330 wears away so as to diminish the capacity of firmer 100, extender 110 may be replaced. Replacement is made without removing firmer 100 from mount 30. Instead, a farmer may simply slide the old one of extender 110 and slide in a new one. Hard stop 510 limits the range of motion of extender 110, and when firmer 100 is drawn across trough 60 then extender 110 is pressed into hard stop 510.

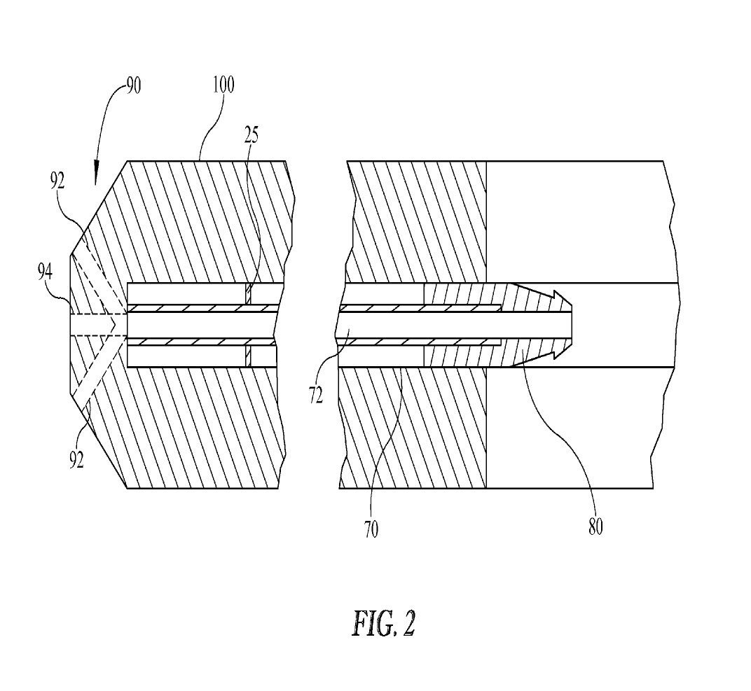

Firmer 100 also has an elongated interior channel 70 which is structured and arranged to receive tube 72, which in the disclosed embodiment is a convention liquid delivery tube, for delivering liquid on or near an embedded one of seeds 50 (see FIGS. 2 and 5). An open end of interior channel 70 is configured to receive nipple 80, which serves as a fluid connection between supply tube 20 and interior tube 72. Interior tube 72 is disposed within channel 70 and supported by tube holder 25, which in one embodiment includes a washer-shaped piece having a perimeter roughly congruent to the shape of interior channel 70.

End point 90 may be configured to be an outlet at one end of channel 70, with that end of channel 70 initially manufacture so that end point 90 closes one end of channel 70. This allows customization of a single piece, so that the exit holes may be drilled to suit the particular application. For example, a straight hole in facing surface 94 delivers liquid directly over embedded seed 50 (a “straight shooter”), which may be good for an insecticide, while side surfaces 92 may have holes drilled in them so that liquid is delivered on each side of embedded seed 50 (a “split shooter”), which may be better for fertilizer. In one embodiment (not shown), channel 70 is structured and arranged to accommodate multiple tube so that a series of end points are associated with each tube, allowing for combinations of straight shooters and split shooters in a single seed firmer.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A seed firmer for embedding seeds into soil, said seed firmer comprising:
a flexible portion adapted to be coupled to a seed chute of a planter;
a firming arm flexibly connected to said flexible portion, said firming arm including an engagement portion bounded at one end by a stop; and
an extender attachment mechanically coupled to said engagement portion and abutting said stop.

2. The seed firmer of claim 1 wherein said extender has a T-shaped tongue.

3. The seed firmer of claim 2 wherein said engagement portion has a slot structured and arranged to receive said tongue.

4. The seed firmer of claim 1 wherein said firming arm includes an interior channel.

5. The seed firmer of claim 4 further comprising a tube extending through said interior channel.

6. The seed firmer of claim 5 wherein said tube terminates at an end of said firming arm.

7. The seed firmer of claim 6 wherein said end includes a hole structured and arranged to deliver liquid existing said tube proximate an end of the firming arm.

8. A seed firmer for embedding seeds into soil, said seed firmer comprising:
a flexible portion adapted to be attached to a seed chute of a planter;
a firming arm flexibly connected to said flexible portion, said firming arm having an aperture structured and arranged to receive a tube, said aperture having a first open end and a second end terminating in at least two alternate fluid flow paths, wherein a hole in either of the alternate fluid flow paths delivers fluid from the tube to a specific orientation relative to said firming arm.

9. The seed firmer of claim 8 further comprising an extender attachment mechanically coupled to an engagement portion of said firming arm.

10. The seed firmer of claim 9 wherein said extender has a T-shaped tongue.

11. The seed firmer of claim 10 wherein said engagement portion has a slot structured and arranged to receive said tongue.

12. firmer of claim 11 wherein said engagement portion has a stop for securing the position of said extender.

13. The seed firmer of claim 8 wherein said firming arm includes an interior channel extending within said firming arm.

14. The seed firmer of claim 13 wherein said tube extends through said interior channel.

15. The seed firmer of claim 14 wherein said tube terminates at an end of said firming arm.

16. The seed firmer of claim 15 wherein said end includes a hole structured and arranged to deliver liquid existing said tube proximate an end of the firming arm.

17. A method of manufacturing a seed firmer comprising the steps of:
fabricating a seed firmer with an interior channel terminating in a plurality of flow channels at an end point at one end of the seed firmer;
creating an aperture in the end point in at least one of said flow channels so that liquid from the interior channel may flow through the aperture.
